(19) United States
(12) Patent Application Publication
(10) Pub. No.: US 2013/0255365 A1
(43) Pub. Date: Oct. 3, 2013

(54) Method for Safely Testing Extraction Systems

(71) Applicants: John Joseph Zipay, Friendswood, TX (US); Satish Chandra Reddy, Houston, TX (US); Amber Leigh Newport, Houston, TX (US); Dale Hiram Jennings, League City, TX (US)

(72) Inventors: John Joseph Zipay, Friendswood, TX (US); Satish Chandra Reddy, Houston, TX (US); Amber Leigh Newport, Houston, TX (US); Dale Hiram Jennings, League City, TX (US)

(21) Appl. No.: 13/431,916

(22) Filed: Mar. 27, 2012

(51) Int. Cl. G01M 99/00

(52) U.S. Cl. CPC G01M 99/007
USPC 73/118.01

(57) ABSTRACT

A method for safely testing extraction systems is developed which allows repeated, reliable and safe actuation of the Extraction Force Transfer Coupling under external load. The unique test set-up invented to perform this testing is described as well as the features of this test rig that are not present in prior art. This novel set-up can be used to characterize the EFTC over a range of external loads and pull angles. It can also be tailored for unique as well as off-nominal EFTC configurations.

This invention relates to the safe, reliable and repeatable testing under external load of the Extraction Force Transfer Coupling (EFTC) that is currently used in the extraction of airdrop platforms from both the C-17 and the C-130 cargo transport aircraft. The present invention allows functional testing of the EFTC at various loading angles and load magnitudes as well as in different hardware configurations to verify its performance in both nominal and off-nominal extraction scenarios.

### BACKGROUND ON INVENTION

This invention was created as part of the investigation into the failure of an EFTC to function during a NASA airdrop of an instrumented platform from a C-130 aircraft on Feb. 9, 2010 (FIG. 1). The platform was destroyed because the EFTC Coupling Link Assembly did not release the Three-Point Link (FIG. 2). This failure to release prevented the parachutes on the platform from deploying. A novel method to test the EFTC under external loading had to be invented in order to isolate the cause of the failure.

### BRIEF SUMMARY OF THE INVENTION

The EFTC is typically tested under external load to verify its strength capability. However, the EFTC is not activated during this testing. A method for testing the release of the Three-Point Link while external load is applied to the EFTC from the extraction chute had never been previously developed. Additionally, the test rig that was invented included the means to apply external loads at combined pitch and yaw angles relative to the EFTC. The entire mechanical system including the Extraction Force Transfer Coupling (EFTC), transfer cable, Coupling Link Assembly (CLA), Three-Point Link and Type V Platform interface are included in the test rig to produce the most realistic test conditions (FIG. 3).

### BRIEF DESCRIPTION OF THE SEVERAL VIEWS OF THE DRAWING

The patent or application file contains at least one photograph executed in color. Copies of this patent or patent application publication with color photographs will be provided by the Office upon request and payment of the necessary fee.

FIG. 1—NASA Instrumented Pallet dropped on Feb. 9, 2010.

FIG. 2—NASA Instrumented Pallet destroyed because the Three-Point Link did not release.

FIG. 3—Major components of the EFTC.

FIG. 4—EFTC with transfer cable and EFTA attached.

FIG. 5—EFTA with cable routing simulated.

FIG. 6—Vertical EFTC test set-up showing actuator, Type XXVI Nylon strap and Vectran restraint lines.

FIG. 7—Horizontal EFTC test set-up showing actuator, Type XXVI Nylon strap and Vectran restraint lines.

FIG. 8—Cut-knife in position to cut yellow lanyard to actuate EFTA. White nylon cord is pulled by hand.

FIG. 9—Bumper to absorb mechanism springback for vertical EFTC testing.

FIG. 10—Bumper to absorb mechanism springback for horizontal EFTC testing.

FIG. 11—EFTC Test Set-up Configuration Drawing

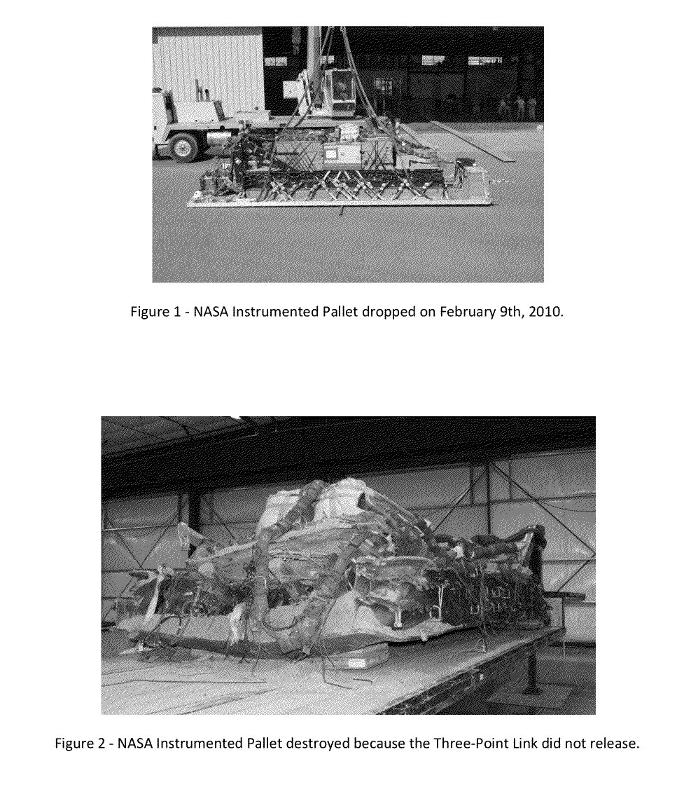

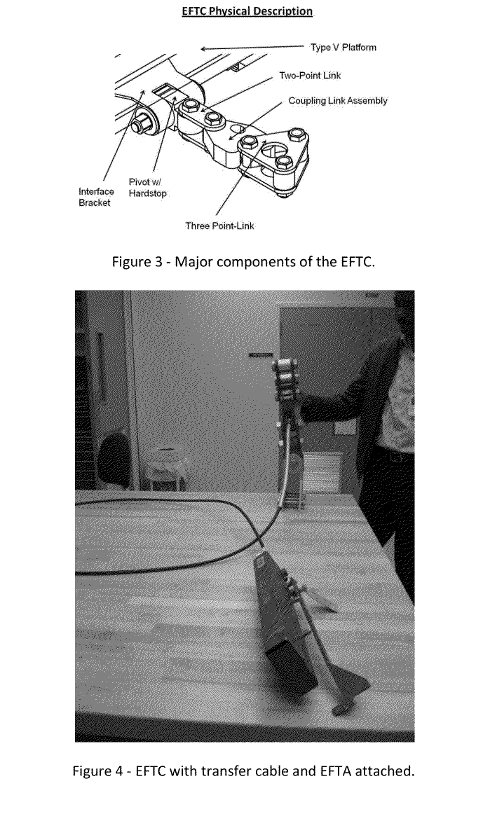

### DETAILED DESCRIPTION OF THE INVENTION

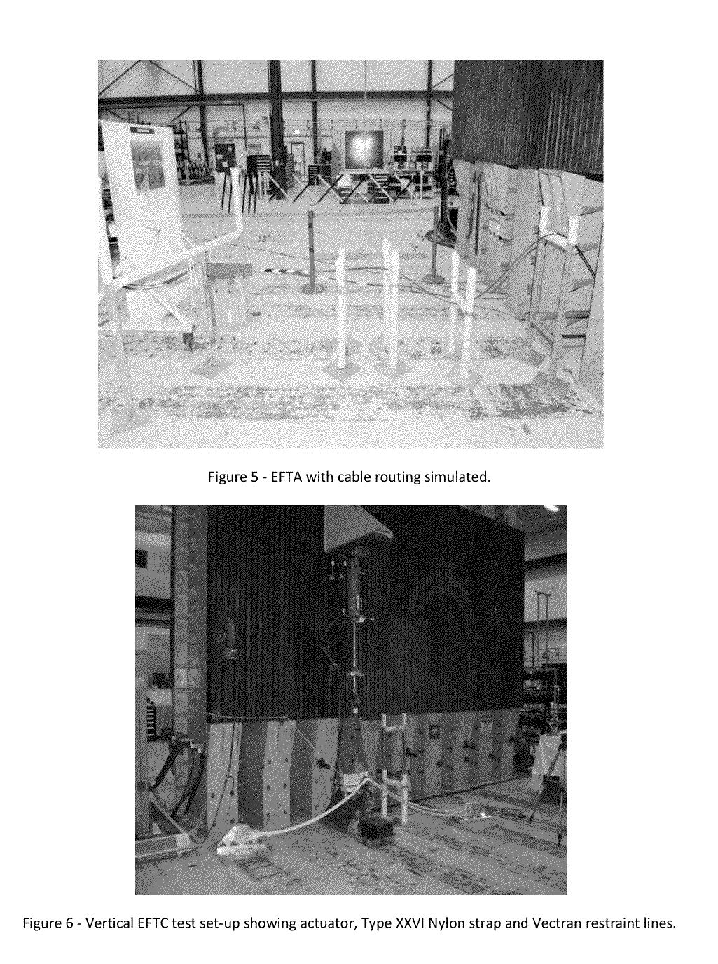

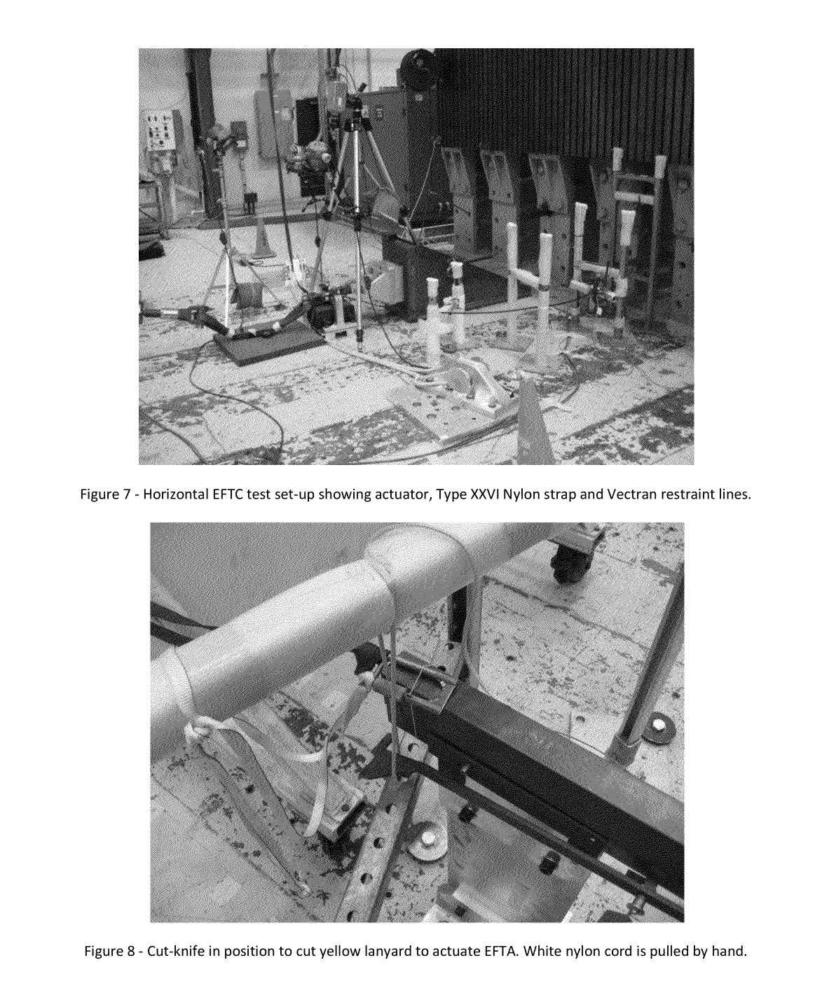

The end-to-end functional testing of the EFTC under load had never been performed prior to this investigation. The test rig set-up and operation are considered to be unique and a first-time invention. It includes not only the EFTC but also the transfer cable and External Force Transfer Actuator (EFTA) (FIG. 4). The transfer cable routing configuration along the platform was simulated (FIG. 5) and a linear actuator attached to a Type XXVI nylon strap were used to load the three-point link through a broad range of angles and magnitudes both vertically (FIG. 6) and horizontally (FIG. 7). Since the three-point link had to be restrained after the Coupling Link Assembly opens, the test rig included redundant Vectran lines that attenuated the energy imparted to the three-point link after it released and also restrained it from damaging itself or the surroundings (FIGS. 6 and 7).

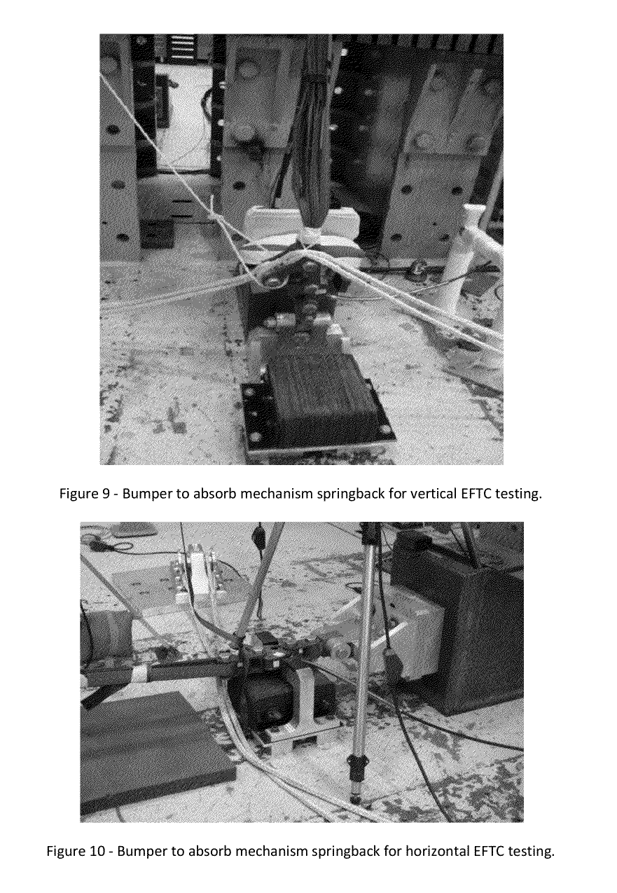

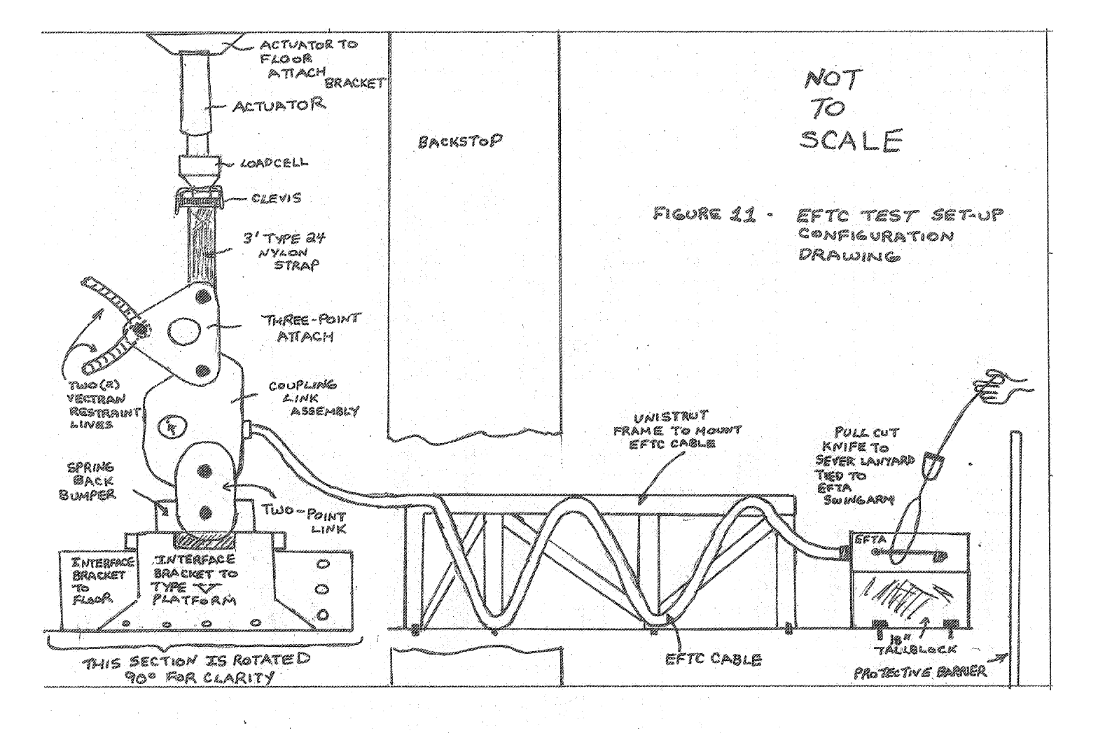

In order to safely operate the Extraction Force Transfer Actuator (EFTA), a scheme was invented whereby the arm was restraint by gutted parachute chord that was manually severed with a cut-knife (FIG. 8). A bumper was also employed to absorb the rebound of the coupling link assembly after the mechanism actuates in both the vertical (FIG. 9) and horizontal (FIG. 10) configuration. This set-up allowed repeated actuation of the EFTC under controlled conditions without damaging any of the hardware components.

Finally, the set-up allowed for change-out of an EFTC component or components to allow for comparative studies of the performance of various pieces of hardware. The EFTA, CLA, transfer cable and three-point link could all be removed and replaced individually or collectively. The set-up also allowed the cable to kinked, bent or crushed and both the EFTA and CLA could be placed in off-nominal configurations in order to test if they had contributed to the test failure.

Testing of the EFTC using the invented test rig was performed at the NASA-Lyndon B. Johnson Space Center in Houston, Tex. during the March-November, 2010 timeframe. It was instrumental in isolating the most probable cause for the drop test failure. NASA report JSC-66097 was prepared to document the results of this testing.

What is claimed is:

1. A unique and heretofore unrealized method for safely testing extraction systems comprised of:
all of the components of the Extraction Force Transfer Coupling configured as an assembly and arranged as they would be during a Low Velocity Air Drop (LVAD) in a manner that allows for changeout of EFTC components for comparative testing
the Extraction Force Transfer Actuator (EFTA) is rigged using a cut knife and lanyard so that it can be repeatedly actuated and released safely by hand.
the Coupling Link Assembly and Three-Point Link can be loaded at various magnitudes including both pitch and yaw angles using a linear actuator to simulate a range of loading conditions at aircraft extraction.
two lengths of Vectran attached to floor anchors which safely restrains the Three-Point Link after the Coupling Link Assembly opens
a bumper to absorb the spring-back energy of the Coupling Link Assembly after mechanism actuation.

2. The configuration of claim 1, wherein no previous test set-up for development, qualification and acceptance testing has simulated the cable routing, hardware spacing and configuration of an actual LVAD drop and permitted for changeout of the CLA, EFTA, Three-Point Link and cable so the comparative performance of the hardware can be tested.

3. The Extraction Force Transfer Actuator rigging of claim 2, wherein the EFTA can be actuated safely and repeatedly by hand. During an actual LVAD, the EFTA swingarm is normally released after the Type V Platform travels down the aircraft ramp. The new rigging scheme invented for this test rig used gutted parachute chord tied around the swing arm and to a piece of test support structure. This chord was severed using a cut knife pulled by a test engineer. This simple set-up allowed the EFTA to be operated safely, reliably and repeatedly. No such set-up for operating the EFTA had existed prior to this invention.

4. The Coupling Link Assembly and Three-Point Link loading of claim 3, wherein the test method invented enables loading of these components across a range of load magnitudes and in both pitch and yaw angles with respect to the mechanism. When the EFTC is qualified, its specification only requires in-line static loading at a single load magnitude without actuation as a workmanship screening test. The test rig invented to help isolate the airdrop test failure loads the Coupling Link Assembly up to 15,000 lbs at angles ranging from 8 degrees of pitch combined with 4 degrees of yaw in both the horizontal and vertical orientations (to include the effects of gravity).

5. The two lengths of Vectran and floor anchors of claim 5, wherein the three-point link can be restrained after the Coupling Link Assembly is actuated is a new invention which permits the EFTC to be actuated safely and repeatedly. The three-point link is an 8-lb mass that is the primary load path for the extraction chute. It is released from the CLA at approximately 100 miles per hour. In order for testing of the entire assembly to be performed at all, the kinetic energy of the link had to be dissipated as strain energy in the Vectran cord. Vectran provides the elasticity to absorb the energy and has the strength and toughness to withstand repeated releases of the Three-Point Link. No other test rig prior to the one developed for this application permitted release of the Three-Point Link while the mechanism was under load.

6. The bumper to absorb the spring back energy of the Coupling Link Assembly in claim 6, wherein the test hardware was protected from damage due to the release of the strain energy that had built up in the mechanism prior to actuation. The release of the Three-Point Link causes the Coupling Link Assembly to react violently. The spring back bumper helps absorb this kinetic energy so that it does not damage the attachment between the CLA and the Type V Platform. This feature enabled multiple test runs at high load to be repeated because the CLA was not damaged between each run. No other set-up has included this feature that permits repeated mechanism actuations under load without damage to the EFTC hardware.
